(19) United States
(12) Patent Application Publication
(10) Pub. No.: US 2026/0252907 A1
(43) Pub. Date: Aug. 27, 2026

(54) ITERATIVE BOOTSTRAPPING FOR MIXTURE DATA GENERATION AND TRAINING OF LANGUAGE MODELS

(71) Applicant: NVIDIA CORPORATION, Santa Clara, CA (US)

(72) Inventors: Shizhe DIAO, Milpitas, CA (US); Peter BELCAK, Mountain View, CA (US); Zijia CHEN, Sunnyvale, CA (US); Xin DONG, San Jose, CA (US); Yonggan FU, Santa Clara, CA (US); Jan KAUTZ, Lexington, MA (US); Yingyan LIN, Dunwoody, GA (US); Pavlo MOLCHANOV, Mountain View, CA (US); Mostofa PATWARY, Fremont, CA (US); Dan SU, San Jose, CA (US); Yoshihiko SUHARA, Los Altos, CA (US); Yu YANG, San Francisco, CA (US); Hongxu YIN, San Jose, CA (US)

(21) Appl. No.: 19/364,948

(22) Filed: Oct. 21, 2025

Related U.S. Application Data
(60) Provisional application No. 63/762,454, filed on Feb. 24, 2025.

(51) Int. Cl. G06N 5/01

(52) U.S. Cl. CPC G06N 5/01

(57) ABSTRACT

The disclosed method of training a language model includes generating, based on corpus data, clustered data, performing, based on the clustered data, a plurality of bootstrapping operations to train a first predictor model and generate a mixture configuration, generating, based on the mixture configuration and the clustered data, mixture data, and performing, based on the mixture data, one or more training operations to train a first untrained language model to generate a first trained language model, where the first trained language model processes first input data to generate first output data.

### CROSS-REFERENCE TO RELATED APPLICATIONS

This application claims priority benefit of the United States Provisional Patent Application titled, “TECHNIQUES FOR ITERATIVE BOOTSTRAPPING FOR ENHANCED DATA MIXTURE WEIGHT ESTIMATION,” filed on Feb. 24, 2025, and having Ser. No. 63/762,454. The subject matter of this related application is hereby incorporated herein by reference.

### BACKGROUND

### Technical Field

Embodiments of the present disclosure relate generally to computer science, artificial intelligence, and machine learning, and more specifically, to iterative bootstrapping for mixture data generation and training of language models.

### Description of the Related Art

Language models refer to computational systems designed to process, generate, and analyze natural language text. Such models can predict the likelihood of sequences of words, generate coherent responses to prompts, and perform tasks, such as summarization, translation, question answering, and/or the like. Large language models (LLMs) are a subset of language models trained on vast corpora of text data with a large number (e.g., billions) of parameters, enabling LLMs to capture nuanced semantics, syntax, and context. For example, LLMs have been demonstrated to perform tasks including drafting emails, writing computer code, composing essays, and providing step-by-step reasoning for math problems. LLMs can also be integrated into real-time applications, such as conversational agents, search engines, productivity tools, and customer support systems, and/or used in offline settings for film script writing, biomedical literature mining, legal document review, or large-scale knowledge discovery.

Pre-training an LLM refers to teaching the LLM general patterns of language by having the LLM repeatedly predict the next word or token in sentences across a collection of text. Conventional approaches for pre-training LLMs rely on large-scale datasets that include trillions of tokens or words. The datasets oftentimes combine broad-coverage crawls of the Internet with high-quality curated sources, such as encyclopedic text, scientific publications, code repositories, and domain-specific corpora. During pre-training, the LLM is trained using a next-token prediction objective that refers to the task of predicting the next word or token in a sequence of text given all the previous words, enabling the model to capture statistical regularities in language across diverse domains.

One drawback of conventional approaches for pre-training LLMs is that large-scale datasets oftentimes lack explicit domain labels, which makes the extraction of relevant content in specialized domains difficult. A domain label refers to a tag or category that indicates what type of content a piece of text belongs to, such as “medical,” “legal,” “programming,” or “fiction.” Without domain labels, the separation of data that is most useful for a particular application, such as pre-training a model to assist with legal research or medical diagnosis, becomes challenging. In addition, conventional approaches for filtering large-scale datasets oftentimes rely on general-purpose heuristics, such as perplexity (e.g., a statistical measure of how predictable text is) or educational value, which may not capture the most informative or highest-quality content for specific use cases. For example, given a dataset that includes a mixture of blog posts, scientific papers, and random internet text, general-purpose heuristics can overlook subtle but important differences in the quality and relevance of different pieces of data.

Another drawback of conventional approaches for pre-training LLMs is that even with curated datasets that include domain labels, selecting optimal mixture data remains non-trivial due to the complex, nonlinear relationship between dataset composition and model performance. Mixture data refers to the specific combination of different types of training data, such as news articles, scientific papers, computer code, or encyclopedic content, and the proportions of each type that are used when training an LLM. There is no straightforward formula that specifies exactly how much of each type of data to include when training an LLM. Adding more of one type of data, such as computer code, does not necessarily result in better coding performance, because the LLM could also depend on related knowledge to reason effectively. For example, optimizing an LLM for coding tasks typically requires not only programming-related data but also complementary material from mathematics, logic, natural language reasoning, and security, because writing code often involves solving math problems, understanding abstract rules, and ensuring correctness in ways that extend beyond programming syntax alone.

As the foregoing illustrates, what is needed in the art are more effective techniques for training language models.

### SUMMARY

According to some embodiments, a computer-implemented method for training a language model includes generating, based on corpus data, clustered data. The method also includes performing, based on the clustered data, a plurality of bootstrapping operations to train a first predictor model and generate a mixture configuration. The method further includes generating, based on the mixture configuration and the clustered data, mixture data. Furthermore, the method includes performing, based on the mixture data, one or more training operations to train a first untrained language model to generate a first trained language model, where the first trained language model processes first input data to generate first output data.

Further embodiments provide, among other things, non-transitory computer-readable storage media storing instructions and systems configured to implement the method set forth above.

At least one technical advantage of the disclosed techniques relative to the prior art is that the disclosed techniques overcome the lack of explicit domain labels and the difficulty of selecting optimal mixture data by clustering corpus data into semantically meaningful clusters that act as effective substitutes for domain labels, enabling more accurate identification of relevant data types without requiring manual annotation. The disclosed techniques also use machine learning models to iteratively evaluate, prune, and optimize mixture configurations, which can automatically determine the proportions of complementary data types that yield better performance when used to train a language model. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3 is a more detailed illustration of the clustering module of FIG. 1, according to various embodiments;

FIG. 4 is a more detailed illustration of the mixture bootstrapping module of FIG. 1, according to various embodiments;

FIG. 5 illustrates how the model trainer of FIG. 1 trains the language model of FIG. 1, according to various embodiments;

FIG. 6 is a more detailed illustration of the application of FIG. 1, according to various embodiments;

FIG. 7 is a flow diagram of method steps for generating clustered data, according to various embodiments;

FIG. 8 is a flow diagram of method steps for generating an optimized mixture configuration, according to various embodiments;

FIG. 9 is a flow diagram of method steps for training a language model, according to various embodiments; and

FIG. 10 is a flow diagram of method steps for generating output data using a trained language model, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for iterative bootstrapping for mixture data generation. In some embodiments, a clustering module processes a corpus of text data and generates clustered data that includes clusters of the text data. The clustering module includes an embedding generator, an initial clustering generator, a cluster pruner, and a cluster merger. The embedding generator processes the corpus data and generates one or more embeddings. The initial clustering generator clusters the embeddings and generates one or more initial clusters. The cluster pruner prunes the initial clusters and generates pruned clusters. The cluster merger performs merging on the pruned clusters to generate the clustered data. In addition, a mixture bootstrapping module performs one or more bootstrapping operations to generate an optimized mixture configuration based on the clustered data. The mixture bootstrapping module includes a mixture configuration generator, a mixture configuration pruner, a proxy model training module, a predictor model training module, and an optimization module. The proxy model training module includes one or more proxy models, a proxy model trainer, and a target data calculator. The predictor model training module includes target data, a predictor model trainer, and a predictor model. The mixture configuration pruner includes the predictor model. The optimization module includes the predictor model. During a first iteration of the bootstrapping, the mixture configuration generator processes clustered data and generates initial mixture configurations. The proxy model trainer trains proxy models based on the clustered data and the initial mixture configurations. Once trained, the target data calculator uses the proxy models to calculate target data that indicates the performance of each proxy model trained with one of the initial mixture configurations. The predictor model trainer then trains a predictor model based on the initial mixture configurations and the corresponding target data. At a subsequent iteration, the mixture configuration generator processes clustered data to generate subsequent mixture configurations. The mixture configuration pruner uses the trained predictor model to prune the subsequent mixture configurations, generating pruned mixture configurations. The proxy model trainer then trains the proxy models based on the clustered data and the pruned mixture configurations. Once trained, the target data calculator uses the proxy models to calculate target data corresponding to the pruned mixture configurations. The predictor model trainer trains the predictor model based on all evaluated mixture configurations, including both initial mixture configurations and pruned mixture configurations and the associated target data. The bootstrapping operations continue across multiple iterations, with the mixture configuration generator generating new candidate mixture configurations, the mixture configuration pruner refining the candidate mixture configurations using the predictor model, the proxy model trainer training proxy models, the target data calculator generating target data, and the predictor model trainer training a new predictor model. The bootstrapping operations continue until one or more stopping criteria are met. When bootstrapping is complete, the optimization module uses the trained predictor model from the last iteration to evaluate a large number of candidate mixture configurations and selects the optimized mixture configuration predicted that achieves the best predicted performance. In some embodiments, a model trainer trains a language model based on the optimized mixture configurations and the clustered data. A training data generator processes the clustered data and the optimized mixture configuration and generates optimized mixture data, which includes optimized mixture input data and optimized mixture ground-truth output data. The language model processes the optimized mixture input data and generates predicted output data. A loss calculator compares the predicted output data with the optimized mixture ground-truth output data and calculates a loss. The model trainer uses the loss to update the parameters of the language model. The training continues until one or more stopping criteria are met. Once trained, the trained language model can be used by an application to process input data and generate output data.

The mixture data generation techniques of the present disclosure have many real-world applications. For example, the mixture data generation techniques can be used to construct optimized training datasets for training language models, such as LLMs, that improve performance on domain-specific tasks, such as legal research, biomedical text analysis, or software development. As another example, the techniques can be applied to balance general-purpose and specialized data sources when training language models, resulting in trained language models that maintain broad world knowledge while excelling in targeted areas, such as mathematics, reasoning, or coding. In addition, mixture data generation can be used to create training corpora for training language models in multilingual or cross-domain applications, such as translation systems, customer support assistants, or educational tools, where precise control over the proportion of various data types is beneficial.

The above examples are not in any way intended to be limiting. As persons skilled in the art will appreciate, as a general matter, the techniques for training language models described herein can be implemented in, or used to train language models that are implemented in, any suitable application.

### System Overview

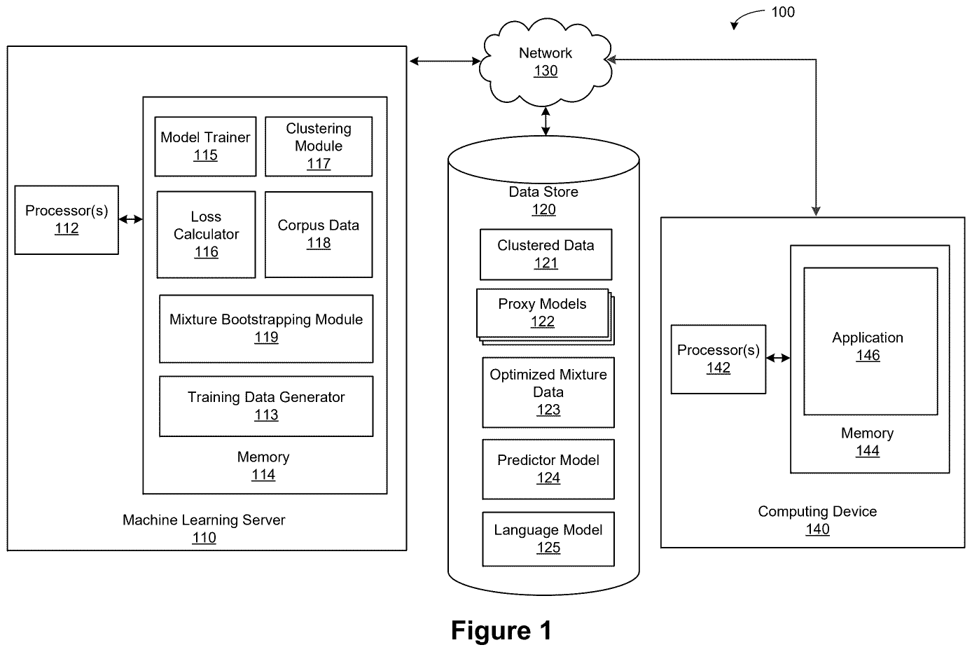

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a loss calculator 116, a clustering module 117, corpus data 118, and a mixture bootstrapping module 119, and a training data generator 113. Data store 120 includes, without limitation, clustered data 121, one or more proxy models 122, optimized mixture data 123, a predictor model 124, and a language model 125. Computing device 140 includes, without limitation, processor(s) 142 and a memory 144. Memory 144 includes, without limitation, an application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 114 of machine learning server 110 stores content, such as software applications and data, for use by processor(s) 112 and the GPU(s) and/or other processing units. Memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the memory 114. The storage can include any number and type of external memories that are accessible to processor(s) 112 and/or the GPU(s). For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in memory 114 can be modified as desired. Further, the connection topology between the various units in FIG. 1 can be modified as desired. In some embodiments, any combination of processor(s) 112, memory 114, and/or GPU(s) can be included in and/or replaced with any type of virtual computing system, distributed computing system, and/or cloud computing environment, such as a public, private, or a hybrid cloud system.

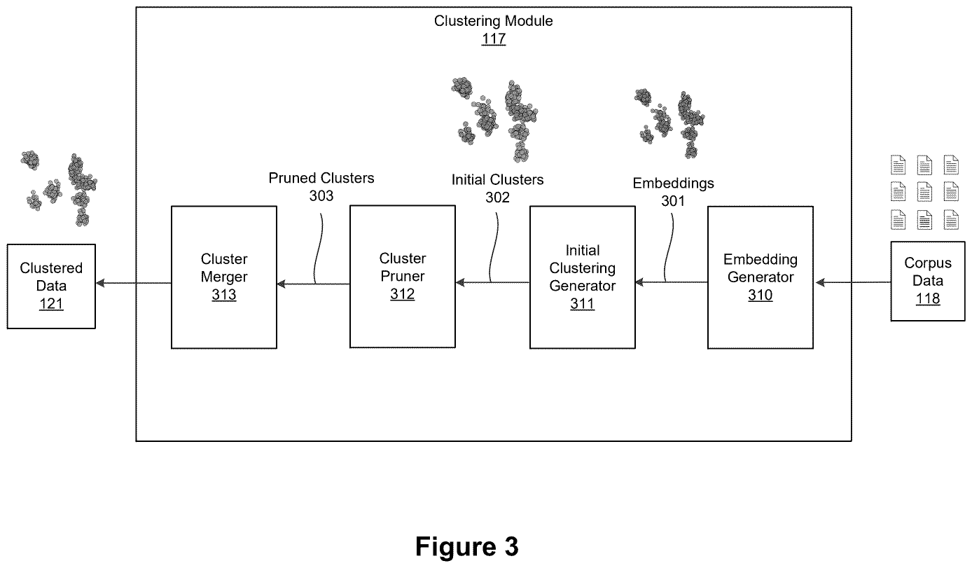

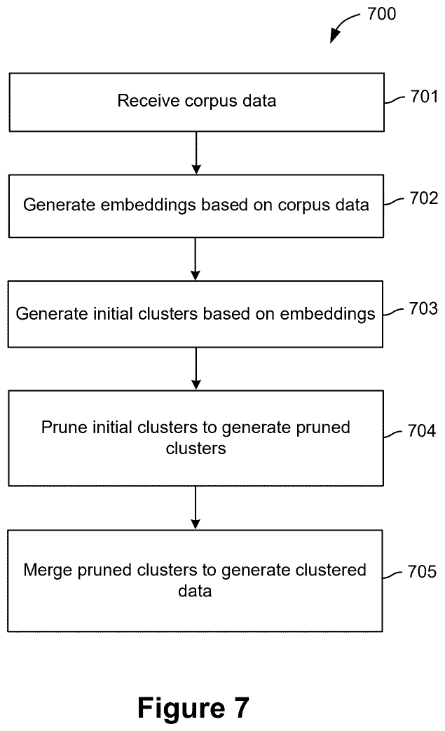

As shown, clustering module 117 executes on one or more processors 112 of machine learning server 110 and is stored in memory 114 of machine learning server 110. In some embodiments, clustering module 117 is an application or module thereof that processes corpus data 118 and generates clustered data 121. Corpus data 118 includes a large-scale collection of raw data that, for example, can include text documents, images, audio recordings, video content, software repositories, and/or other forms of digital data. Clustered data 121 stored in data store 120 includes groups of related data items obtained by applying one or more clustering techniques, such as using clustering module 117, to corpus data 118, such that semantically or structurally similar items are grouped together into latent domains. For example, corpus data 118 could include a mixture of legal opinions, medical research articles, programming tutorials, scientific diagrams, speech transcripts, and/or instructional videos. In such cases, clustered data 121 can include separate clusters corresponding to legal materials, biomedical materials, software-related content, visual scientific figures, spoken dialogue, and/or instructional video data. Clustering module 117 is described in greater detail herein in conjunction with at least FIGS. 3 and 7.

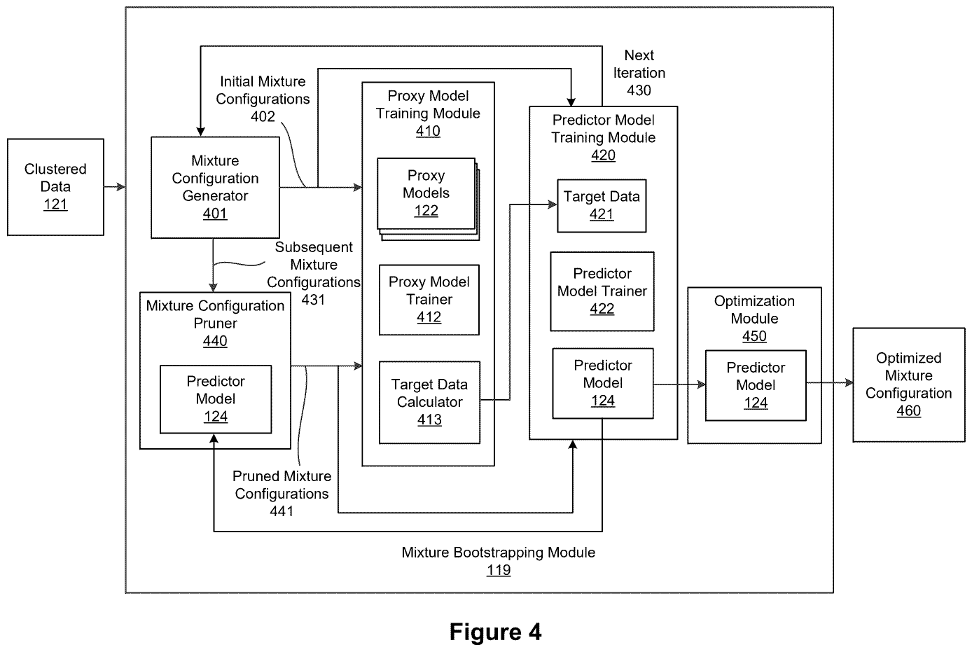

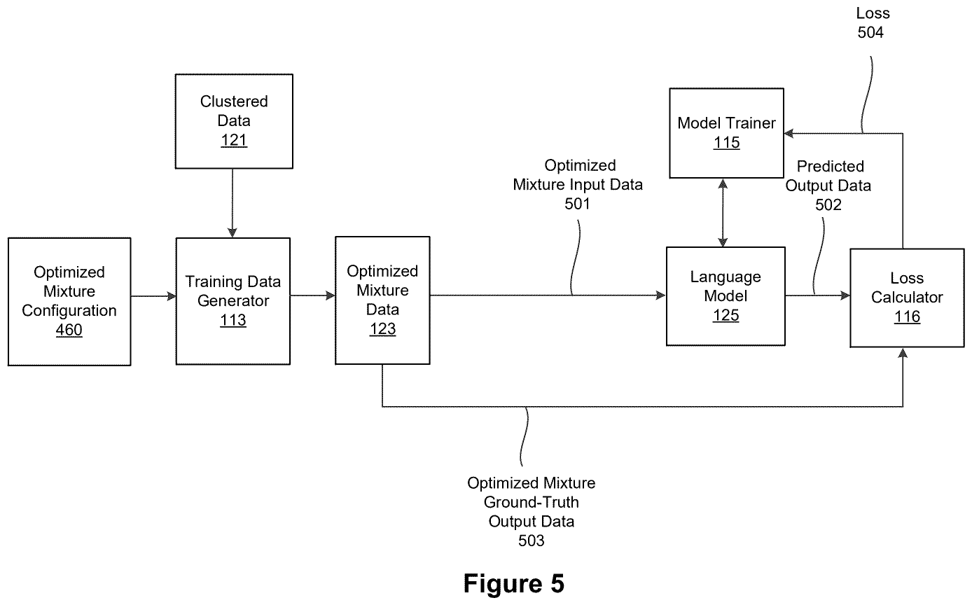

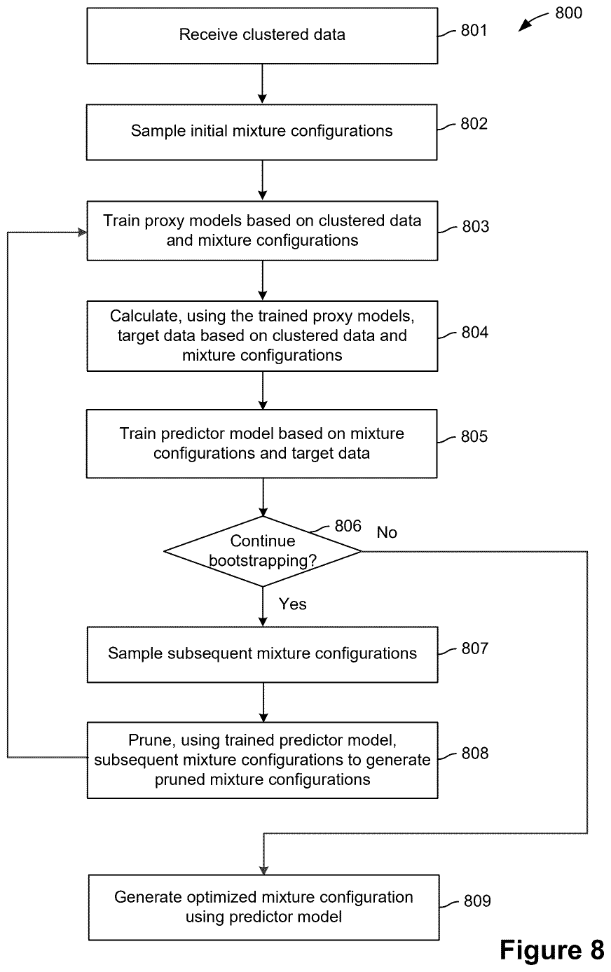

Mixture bootstrapping module 119 is an application or module thereof that executes on one or more processors 112 of machine learning server 110 and is stored in a memory 114 of machine learning server 110. In some embodiments, mixture bootstrapping module 119 performs, using proxy models 122 and predictor model 124, one or more bootstrapping operations to generate optimized mixture data 123 stored in data store 120 based on clustered data 121. Proxy models 122 are each a machine learning model, such as a language model, that are trained by a first model trainer at each bootstrapping step to generate output data that includes text data. Predictor model 124 is a machine learning model, such as a regressor, which is trained by a second model trainer at each bootstrapping step to generate target data. Optimized mixture data 123 includes a curated and reweighted combination of clustered data 121 that is selected based on an optimal mixture configuration determined via iterative evaluations of candidate mixtures during the one or more bootstrapping operations. For example, the optimal mixture configuration could specify that a training dataset should include 40% programming-related content, 25% biomedical content, 20% mathematical reasoning content, and 15% general web text. Training data generator 113 generates optimized mixture data 123 based on such an optimal mixture configuration and clustered data 121. Mixture bootstrapping module 119 is described in greater detail herein in conjunction with at least FIGS. 4 and 8. Training data generator 113 is described in greater detail herein in conjunction with at least FIG. 5.

As shown, model trainer 115 is an application that executes on one or more processors 112 of machine learning server 110 and is stored in a memory 114 of machine learning server 110. Although shown as distinct from loss calculator 116, clustering module 117, and mixture bootstrapping module 119 for illustrative purposes, in some embodiments, functionality of model trainer 115, loss calculator 116, clustering module 117, mixture bootstrapping module 119, and/or training data generator 113 can be combined into a single application or any number of applications.

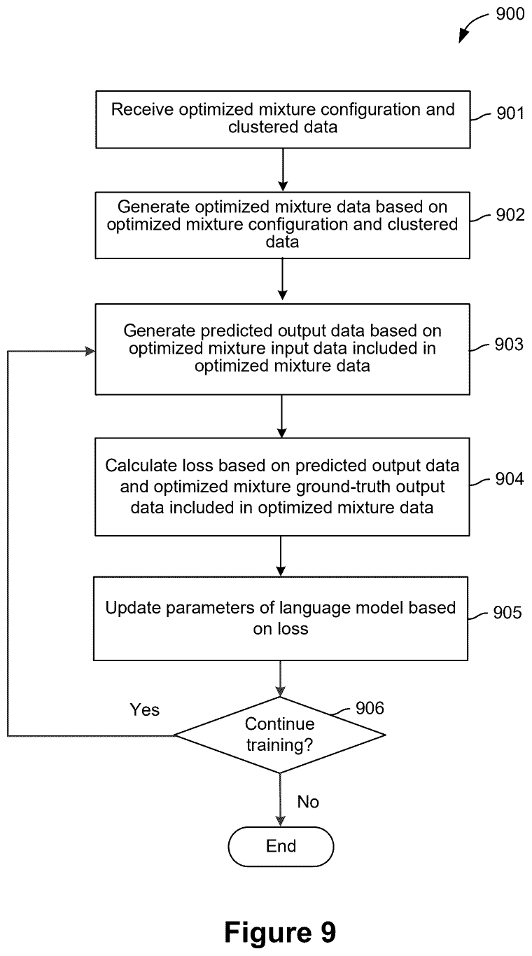

In some embodiments, model trainer 115 is configured to train one or more machine learning models, including language model 125. Language model 125 is a machine learning model, such as a neural network, which is trained to generate output data that includes text data. Techniques for training language model 125 are discussed in greater detail herein in conjunction with at least FIGS. 5 and 9. Language model 125 can be stored in data store 120. Although shown as being stored in data store 120 in FIG. 1, language model 125 can be stored in memory 114 during training or can be stored in memory 144 during inference. In some embodiments, the same computing device(s) can be used for training and inference after training, rather than the separate machine learning server 110 and computing device 140. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, loss calculator 116 executes on one or more processors 112 of machine learning server 110 and is stored in memory 114 of machine learning server 110. In some embodiments, loss calculator 116 is an application or module thereof that calculates a loss for training language model 125 based on output data generated by language model 125 and optimized ground-truth output data included in optimized mixture output data 123.

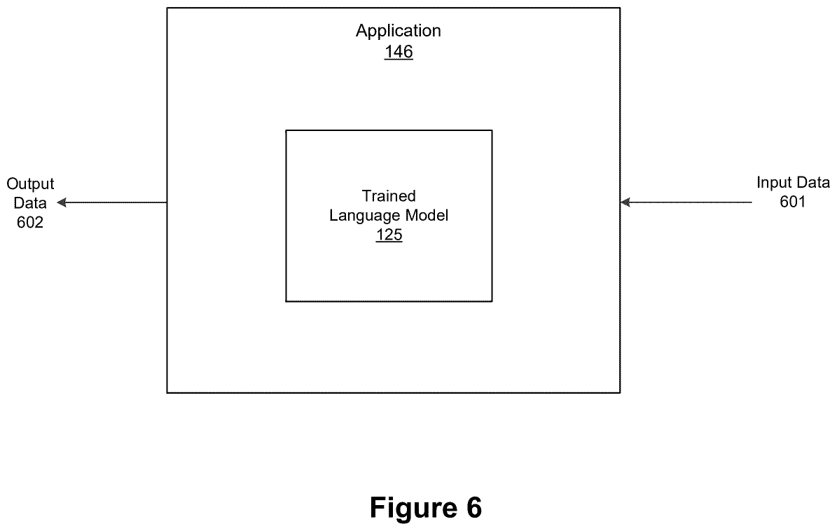

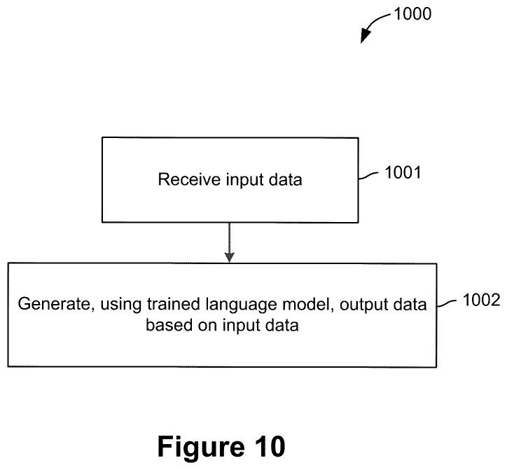

As shown, application 146 that uses the trained language model 125 is stored in memory 144, and executes on processor(s) 142, of computer device 140. Once trained, language model 125 can be deployed, such as via application 146, to process first input data. Memory 144 and the processor(s) 142 can be similar to memory 114 and processor(s) 112 of machine learning server 110, described above. Application 146 is discussed in greater detail herein in conjunction with at least FIGS. 6 and 10.

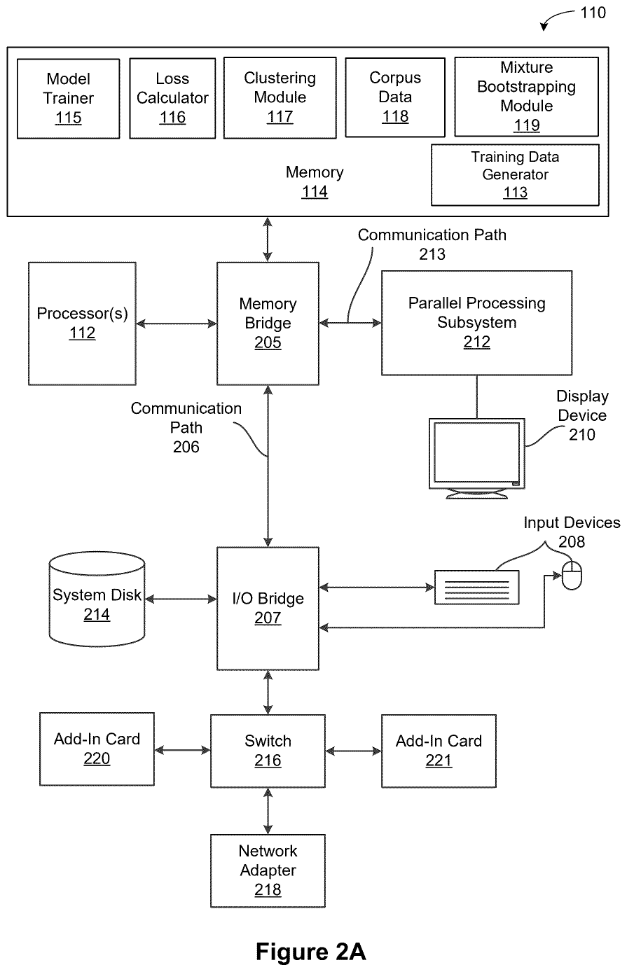

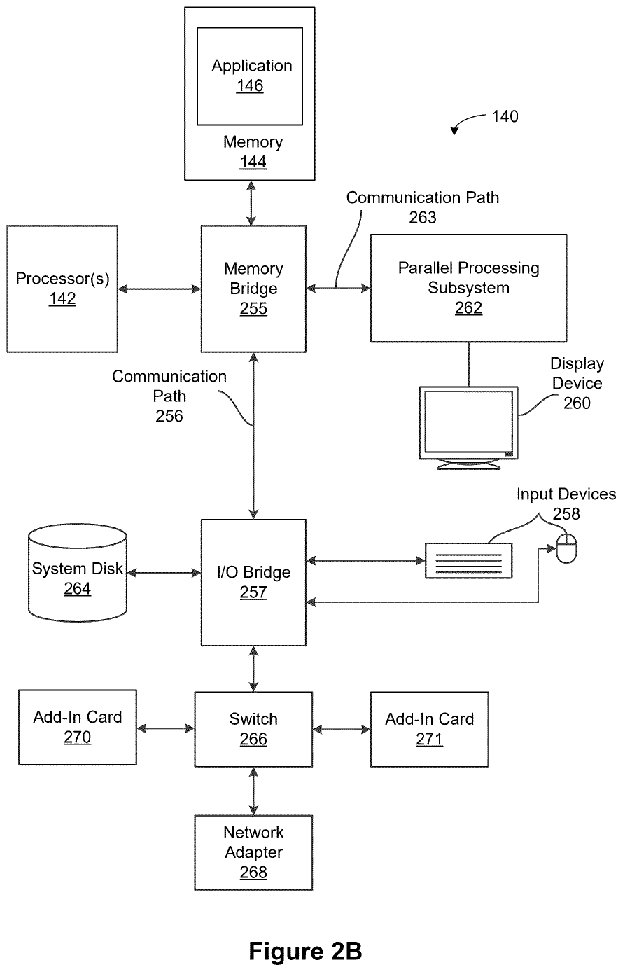

FIG. 2A is a block diagram illustrating machine learning server 110 of FIG. 1 in greater detail, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. Memory 114 includes at least one device driver configured to manage the processing operations of the one or more PPUs within parallel processing subsystem 212. In addition, memory 114 includes, without limitation, model trainer 115, loss calculator 116, clustering module 117, corpus data 118, mixture bootstrapping module 119, and training data generator 113. Although described herein primarily with respect to model trainer 115, loss calculator 116, clustering module 117, corpus data 118, mixture bootstrapping module 119, and training data generator 113, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, memory 114 could be connected to the processor(s) 112 directly rather than through memory bridge 205, and other devices may communicate with memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a block diagram illustrating computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

In various embodiments, computing device 140 includes, without limitation, processor(s) 142 and memory (ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes application 146. Although described herein primarily with respect to application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor(s) 142. In other embodiments, parallel processing subsystem 262 may be connected to I/O bridge 257 or directly to processor(s) 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Iterative Bootstrapping for Mixture Data Generation and Training of Language Models

FIG. 3 is a more detailed illustration of clustering module 117 of FIG. 1, according to various embodiments. As shown, clustering module 117 includes, without limitation, an embedding generator 310, an initial clustering generator 311, a cluster pruner 312, and a cluster merger 314. In operation, embedding generator 310 processes corpus data 118 and generates embeddings 301. Initial clustering generator 311 processes embeddings 301 and generates initial clusters 302. Cluster pruner 312 processes initial clusters 302 and generates pruned clusters 303. Custer merger 313 processes pruned clusters 303 and generates clustered data 121.

Embedding generator 310 is a submodule of clustering module 117 that processes corpus data 118 and generates embeddings 301. In some embodiments, corpus data 118 includes a large dataset \hat{D}={D₁, D₂, . . . , Dₙ} including n data items, such as documents, images, audio recordings, or video segments. Embedding generator 310 maps each data item Dᵢ into an embedding space using an embedding model Mₑ. Examples of the embedding model can include, without limitation, text encoders, such as Bidirectional Encoder Representations from Transformers (BERT), Generative Pre-trained Transformer (GPT) encoders, or Sentence-BERT (SBERT); image encoders, such as Vision Transformer (ViT) or CLIP; and multimodal encoders capable of jointly processing text, image, and audio content. The output of embedding generator 310 is a set of embedding vectors E={E₁, E₂, . . . , Eₙ} included in embeddings 301, where each embedding vector Et corresponds to a semantic or structural representation of the respective data item Dᵢ. The embedding vectors capture similarities among the data items in a continuous vector space, thereby enabling subsequent clustering operations to group semantically related or contextually aligned items into clusters.

Initial clustering generator 311 is a submodule of clustering module 117 that processes embeddings 301 and generates initial clusters 302. In some embodiments, initial clustering generator 311 applies one or more clustering algorithms to group embeddings 301 into k clusters, C={C₁, C₂, . . . , Cₖ}, such that first embeddings 301 within the same cluster are more similar to each other than to second embeddings 301 in different clusters. For example, initial clustering generator 311 can apply algorithms, such as k-means clustering, hierarchical agglomerative clustering, spectral clustering, or density-based spatial clustering of applications with noise (DBSCAN). Each initial cluster 302 includes a subset of embedding vectors included in embeddings 301 corresponding to data items that share semantic or structural similarity, such as legal documents grouped together, biomedical research grouped together, and/or images depicting similar objects grouped together.

Cluster pruner 312 is a submodule of clustering module 117 that processes initial clusters 302 and generates pruned clusters 303. In some embodiments, cluster pruner 312 evaluates each initial cluster 302 according to one or more quality metrics and prunes initial clusters 302 that do not meet predefined criteria. The quality metrics can include, without limitation, cluster size, intra-cluster similarity, inter-cluster separation, and/or domain relevance scores calculated by one or more auxiliary classifiers. For example, in some embodiments, cluster pruner 312 can prune clusters based on scores computed across quality dimensions, such as overall quality, educational value, informational value, or advertisement level, using auxiliary models, such as fastText or large-scale classifiers. In some examples, a cluster-level pruning threshold (e.g., 3.0) is applied to reduce Kᵢₙᵢₜ=1000 initial clusters 302 down to K_{pruned}=240 pruned clusters 303. In some embodiments, cluster pruner 312 also discards initial clusters 302 containing fewer than a threshold number of items, clusters with low average similarity among embeddings, or clusters dominated by low-quality or noisy data, such as malformed text, corrupted images, or irrelevant audio fragments.

Cluster merger 313 is a submodule of clustering module 117 that processes pruned clusters 303 and generates clustered data 121. In some embodiments, cluster merger 313 merges similar fine-grained clusters included in pruned clusters 303 to reduce the overall number of clusters while preserving domain coherence. Specifically, given an initial number of clusters Kᵢₙᵢₜ, cluster pruner 312 reduces the set to K_{pruned} high-quality clusters. Cluster merger 313 then merges the K_{pruned} clusters into K_{enhanced} clusters according to the distance between cluster centroids, where K_{enhanced}<K_{pruned}<Kᵢₙᵢₜ. In some embodiment, cluster merger 313 groups clusters according to a Euclidean distance threshold, such as 1.5, ensuring that pruned clusters 303 with centroids closer than the threshold are merged.

FIG. 4 is a more detailed illustration of mixture bootstrapping module 119, according to various embodiments. As shown, mixture bootstrapping module 119 includes, without limitation, a mixture configuration generator 401, a proxy model training module 410, a predictor model training module 420, a mixture configuration pruner 440, and an optimization module 450. Proxy model training module 410 includes, without limitation, mixture data 411, proxy models 122, a proxy model trainer 412, and a target data calculator 413. Predictor model training module 420 includes, without limitation, target data 421, a predictor model trainer 422, and a predictor model 124. Mixture configuration pruner 440 includes, without limitation, predictor model 124. Optimization module 450 includes, without limitation, predictor model 124. In operation, mixture bootstrapping module 119 performs, using proxy models 122 and predictor model 124, one or more bootstrapping operations to generate optimized mixture configuration 460 based on clustered data 121. At the first iteration, mixture configuration generator 401 processes clustered data 121 and generates initial mixture configurations 402. Proxy model trainer 412 trains proxy models 122 based on initial mixture configurations 402 and clustered data 121. Once trained, target data calculator 413 uses the trained proxy models 122 to calculate target data 421 indicating the performance of each trained proxy model 122 that is trained based on clustered data 121 and one of the initial mixture configurations 431. Predictor model trainer 422 trains predictor model 124 based on initial mixture configurations 402 and target data 421. At a next iteration 430, mixture configuration generator 401 processes clustered data 121 to generate subsequent mixture configurations 431. Mixture configuration pruner 440 uses the trained predictor model 124 to prune the subsequent mixture configurations 431 and generate pruned mixture configurations 441. Proxy model trainer 412 trains additional proxy models 122 based on pruned mixture configurations 441 and clustered data 121. Once trained, target data calculator 413 uses the additionally trained proxy models 122 to calculate target data 421 indicating the performance of each additionally trained proxy model 122 that is trained based on clustered data 121 and one of the pruned mixture configurations 441. Predictor model trainer 422 re-trains predictor model 124 based on initial mixture configurations 402, pruned mixture configurations 441, and corresponding target data 421. The bootstrapping operations continue through more iterations that generate additional subsequent mixture configurations 431, prune the additional subsequent mixture configuration 431 to generate additional pruned mixture configurations 441, etc. until one or more stopping criteria are met. Then, optimization module 450 uses the trained predictor model 124 from the last iteration to generate optimized mixture configuration 460.

Mixture bootstrapping module 119 performs one or more bootstrapping operations, using proxy models 122 and predictor model 124, to generate optimized mixture configuration 460 based on clustered data 121. Let clustered data 121 be denoted as D={D₁, D₂, . . . , D_{K}}, where each Dᵢ corresponds to a cluster. In some embodiments, mixture bootstrapping module 119 generates candidate mixture configurations, such as initial mixture configurations 402 and subsequent mixture configurations 431, where each configuration specifies a set of mixture weights α={α₁, α₂, . . . , αₖ} assigned to the clusters, subject to the constraints Σᵢ αᵢ=1 and αᵢ≥0. In some embodiments, the objective of mixture bootstrapping module 119 is to identify the optimal mixture configuration 460 α*∈A that maximizes task performance [symbol] (α, ω), where ω are parameters of language model 125 trained under the given mixture configuration, for example, as described by

$${min}_{α ∈ A} {ℓ}_{val} ( α , {ω}^{*} ( α ) ) s . t . {ω}^{*} ( α ) = arg {min}_{ω} {ℓ}_{train} ( α , ω ) . \qquad ( Equation 1 )$$

In some embodiments, directly evaluating the objective in Equation 1 requires training a full-scale language model 125 for each candidate mixture configuration, which is computationally prohibitive. Instead, mixture bootstrapping module 119 uses predictor model 124 to approximate the performance function in Equation 1. During each bootstrapping operation, mixture bootstrapping module 119 samples a subset S⊆A of candidate mixture configurations (e.g., initial mixture configuration 402 during the first iteration or subsequent mixture configurations 431 during subsequent iterations), evaluates the subset using proxy models 122 to obtain target values included in target data 421, and trains predictor model 124 on the resulting mixture configuration and target value pairs. In some examples, the approximate optimization problem can be written as:

$${min}_{α ∈ A} {f}_{θ} ( α \vert S ) s . t . f = arg {min}_{s , f ∈ ℱ} {\sum }_{s ∈ S} ℒ ( f ( s ) , ℓ ( s , {ω}^{*} ) ) . \qquad ( Equation 2 )$$

In Equation 2, f_{θ} is predictor model 124 with parameters θ, [symbol] represents the set of possible approximations to [symbol] , [symbol] is the loss function used for training predictor model 124, and S⊆A denotes a subset of candidate mixture configurations constrained by |S|≤C. The value of C corresponds to the total training cost of proxy models 122. By leveraging the iterative evaluation and prediction process, mixture bootstrapping module 119 searches the configuration space for high-quality mixtures and generates optimized mixture configuration 460 without requiring exhaustive training across all candidate configurations.

Mixture configuration generator 401 is a submodule of mixture bootstrapping module 119 that processes clustered data 121 and generates initial mixture configurations 402 during a first iteration of the bootstrapping and subsequent mixture configurations 431 during subsequent iterations of the bootstrapping. In some embodiments, each mixture configuration specifies a set of mixture weights α={α₁, α₂, . . . , αₖ} assigned to the clusters included in clustered data 121. Each mixture weight αᵢ corresponds to a proportion of data sampled from cluster Dᵢ, such that the mixture configuration satisfies the normalization constraint

$${\sum }_{i = 1}^{k} {α}_{i} = 1$$

with αᵢ≥0. In some embodiments, at the first iteration, the mixture weights are initialized uniformly (e.g., αᵢ=1/k for all i) to permit balanced coverage across the clusters. In some embodiments, the mixture weights are initialized according to heuristics, such as cluster size, cluster quality scores, or external cluster priorities. After the first iteration, mixture configuration generator 401 generates subsequent mixture configurations 401 in a similar manner based on clustered data 121.

Proxy models 122 process input data and generate output data. In some embodiments, proxy models 122 processes input data included in clustered data 121 sampled according to mixture configurations, such as initial mixture configurations 402 during a first iteration of the bootstrapping or pruned mixture configurations 441 that are generated by pruning subsequent mixture configuration 431 during subsequent iterations of the bootstrapping, and generate output data. In some embodiments, proxy models 122 are trained to approximate the behavior of language model 125 while being computationally efficient to train and evaluate. Examples of proxy models include, without limitation, lightweight language models for text data, convolutional neural networks (CNNs) or vision transformers (ViTs) for image data, and recurrent neural networks (RNNs) or wav2vec-style encoders for audio data. The output data includes, without limitation, text, predictions, classifications, and/or embeddings that are compared to benchmark references to evaluate performance.

Proxy model trainer 421 is a submodule of proxy model training module 410 that trains proxy models 122 based on clustered data 121 and at least one of initial mixture configurations 402 or pruned mixture configurations 441. In some embodiments, proxy model trainer 421 uses data included in clustered data 121 sampled according to mixture configurations as the training data. In some embodiments, proxy model trainer 421 selects a subset of training pairs (xᵢ, yᵢ), where xᵢ represents an input data item and yᵢ represents a corresponding ground-truth label or reference output. Proxy model trainer 421 updates the parameters of each proxy model 122 by minimizing a task-specific loss function [symbol] (ŷᵢ, yᵢ), where ŷᵢ is the output predicted by the proxy model 122 for input xᵢ. In some examples, the loss function can include a cross-entropy loss for classification tasks, a mean squared error for regression tasks, a contrastive loss for representation learning tasks, a next token prediction loss for text generation tasks, and/or any other technically feasible loss. Proxy model trainer 421 performs one or more training operations until a convergence criterion is satisfied, such as reaching a maximum number of epochs, achieving a threshold validation accuracy, or meeting a predefined loss threshold. Once trained, proxy model trainer 421 stores the trained proxy models 122 in data store 120 or elsewhere.

Target data calculator 422 is a submodule of mixture bootstrapping module 119 that uses the trained proxy models 122 to calculate target data 431 based on clustered data 121 and at least one of initial mixture configurations 402 or pruned mixture configurations 441. In some embodiments, target data calculator 422 evaluates the performance of proxy models 122 on benchmark tasks or validation datasets to generate measurable scores. For a given mixture configuration s included in at least one of initial mixture configurations 402 or pruned mixture configurations 441, and a trained proxy model 122 applied to data sampled according to s from clustered data 121, target data calculator 422 computes a vector of performance values [symbol] (s)=( [symbol] ₁(s), [symbol] ₂(s), . . . , [symbol] ₘ(s)), where each [symbol] ⱼ(s) corresponds to the performance of the proxy model 122 on benchmark task j, measured using one or more evaluation metrics, such as accuracy, F1 score, bilingual evaluation understudy (BLEU), perplexity, mean squared error (MSE), and/or the like. Target data calculator 422 then calculates target values based on performance values and representing a single optimization objective that can be used to guide mixture selection. In some embodiments, target data calculator 422 computes a target value t(s)=g( [symbol] (s)), where g(·) is an aggregation function, such as averaging, weighted averaging, task-specific weighting, and/or the like. For example, raw performance values, such as 70% accuracy on a programming benchmark, 65% accuracy on a reasoning benchmark, and 55% accuracy on a mathematics benchmark, can be combined into a single mean target value of 63%. In some embodiments, the target values included in target data 421 are domain-specific. For example, one target value could be computed for biomedical tasks, another target value for coding tasks, and yet another target value for multilingual reasoning tasks. The resulting target data 431 therefore includes one or more target values t(s) associated with each mixture configuration s included in at least one of initial mixture configurations 402 or pruned mixture configurations 441 derived from clustered data 121.

Predictor model 124 processes mixture configurations and generates predicted target data. Given a mixture configuration s E A, predictor model 124 outputs a predicted target value \hat{t}(s)=f_{θ}(s), where f_{θ} denotes the predictor model 124 with learned parameters θ. The predicted target value \hat{t}(s) provides an approximation of the true target value t(s) that would otherwise require training and evaluating language model 125, which is computationally prohibitive. In some embodiments, the true performance of language model 125 trained with mixture configuration s is represented by a performance function l(s, ω) as described in Equation 1, where ω are the parameters of language model 125. However, directly computing l(s, ω) for all candidate s is computationally intractable. Predictor model 124 approximates this performance function using the learned mapping f_{θ}(s)≈t(s). In some embodiments, predictor model 124 is implemented as a regression model, such as linear regression, ridge regression, decision tree regression, or a multilayer perceptron (MLP). In some embodiments, predictor model 124 is implemented using one or more gradient-boosted decision trees, such as Light Gradient Boosted Machine (LightGBM), which predict \hat{t}(s) by learning an ensemble of decision trees. Predictor model 124 can be trained in any technically feasible manner, such as using a mean-squared error (MSE) loss.

Predictor model trainer 124 is a submodule of predictor model training module 420 that trains a predictor model 124 at every iteration of the bootstrapping based on mixture configurations and target data 421. In some embodiments, target data 421 includes one or more target values t(s) associated with mixture configurations s, where each target value reflects the aggregated performance of one of the proxy models 122 on one or more benchmark tasks. Predictor model trainer 424 learns a mapping from mixture configurations to target values by fitting predictor model 124 on pairs (s, t(s)). In some examples, the training objective is to minimize a regression loss function

$$L = {\sum }_{s ∈ S} {( {f}_{θ} ( s ) - t ( s ) )}^{2} ,$$

where f_{θ}(s) is the predicted target value generated by predictor model 124 with parameters θ, and S is the set of evaluated mixture configurations. Predictor model trainer 422 performs one or more training operations until a convergence criterion is satisfied, such as reaching a maximum number of epochs, achieving a threshold validation accuracy, or meeting a predefined loss threshold. Once trained, predictor model trainer 422 stores the trained predictor model 122 in data store 120 or elsewhere.

Mixture data pruner 440 is a submodule of mixture bootstrapping module 119 that, during subsequent iterations of the bootstrapping, uses the trained predictor model 124 from a previous iteration to generate pruned mixture configurations 441 based on subsequent mixture configurations 431. In some embodiments, mixture data pruner 440 uses predictor model 124 to discard low-scoring configurations included in subsequent mixture configurations 431 and retain promising configurations included in subsequent mixture configurations 431 for further evaluation. In some embodiments, pruning follows an iterative coordinate descent framework that alternates between configuration sampling and predictor fitting. In some examples, at iteration k, the unevaluated candidate configurations are scored by predictor model 124 as

$${\tilde{P}}^{( k )} = \{ {f}_{θ}^{( k )} ( s ) \vert s ∈ A ∖ {S}^{( k )} \} , \qquad ( Equation 4 )$$

where S^{(k)} is the evaluated set of mixture configurations at iteration k, and

$${f}_{θ}^{( k )}$$

is the predictor model 124 trained up to iteration k. Mixture data pruner 440 then selects a subset S_{M}⊂Top_{N}(\tilde{P}^{(k)}) of high-scoring candidate configurations, either deterministically (e.g., top-N selection) or stochastically (e.g., random sampling from the top-N). For training a predictor model 124, the set of evaluated candidate configurations is expanded as S^{(k+1)}=S^{(k)} U S_{M}. By training predictor model 124 on the expanded set S^{(k+1)}, mixture data pruner 413 continuously refines estimates of configuration quality, enabling efficient exploration of the design space while reducing evaluation costs. In some examples, the optimization objective at iteration k for training a predictor model 124 using pruned mixture configurations 441 and target data 421 generated by proxy models 122 trained using pruned mixture configurations 441, as well as previously generated mixture configurations and associated target data (if any), is expressed as

$${α}^{*} = arg {min}_{α ∈ A} {f}_{θ} ( α \vert {S}^{( k + 1 )} ) , \qquad ( Equation 5 )$$

with predictor model 124 updated according to

$${f}_{θ}^{( k + 1 )} = arg {min}_{f ∈ ℱ} {\sum }_{s ∈ {S}^{( k + 1 )}} L ( f ( s ) , ℓ ( s , {ω}^{*} ) ) , \qquad ( Equation 6 )$$

where L is a regression loss function and [symbol] (s, ω*) denotes the true proxy-measured performance of configuration s.

In some embodiments, mixture bootstrapping module 119 continues bootstrapping until one or more stopping criteria are satisfied. Stopping criteria can include, without limitation, (i) convergence of predicted target values across successive iterations, (ii) reaching a maximum number of iterations K, and/or (iii) exhaustion of the compute budget C allocated for training proxy models 122. In some embodiments, additional constraints are also applied, such as diversity requirements (e.g., ensuring that no single cluster dominates the mixture configurations), minimum thresholds for certain clusters, and/or domain-specific relevance filters.

When mixture bootstrapping module 119 determines not to continue bootstrapping, optimization module 450 uses the trained predictor model 124 to evaluate a large number of candidate mixture configurations (e.g., 100,000 randomly sampled mixture configurations) and selects optimized mixture configuration 460 predicted to yield the best performance. Optimized mixture configuration 460 includes, without limitation, the mixture weights, sampling proportions, and/or cluster assignments for clustered data 121.

FIG. 5 illustrates how model trainer 115 trains language model 125, according to various embodiments. In operation, training data generator 113 processes optimized mixture configuration 460 and clustered data 121 and generates optimized mixture data 123. Language model 125 processes optimized mixture input data 501 included in optimized mixture data 123 and generates predicted output data 502. Loss calculator 116 calculates a loss 504 based on predicted output data 502 and optimized mixture ground-truth output data 503 included in optimized mixture data 123. Model trainer 115 updates parameters of language model 125 based on loss 504.

Training data generator 113 processes clustered data 121 and optimized mixture configuration 460 and generates optimized mixture data 123. In some embodiments, optimized mixture configuration 460 specifies mixture weights or sampling proportions across one or more clusters included in clustered data 121. Training data generator 113 applies the mixture weights to select and combine the clusters from clustered data 121, generating optimized mixture data 123. The resulting optimized mixture data 123 includes both the selected clusters and the mixture weights that govern the composition. Once optimized mixture data 123 is generated, training data generator 113 stores optimized mixture data 123 in data store 120 or elsewhere.

Language model 125 processes optimized mixture input data 501 included in optimized mixture data 123 and generates predicted output data 502. In some embodiments, optimized mixture input data 501 includes a batch of training examples drawn according to optimized mixture configuration 460, such as text sequences, image-caption pairs, code snippets, and/or multimodal data items. Language model 125 uses the learned parameters to transform optimized mixture input data 501 into predicted output data 502, which can include next-token predictions, classifications, embeddings, and/or other task-specific outputs depending on the training objective. In some embodiments, any technically feasible language model 125 can be used, such as a large language model (LLM), small language model, reasoning model, multimodal model, etc. In some examples, language model 125 can include any technically feasible architecture, such as a Generative Pre-trained Transformer (GPT), Bidirectional Encoder Representations from Transformer (BERT), Text-to-Text Transfer Transformer (T5), Large Language Model Meta AI (LLAMA), Pathways Language Model (PaLM), and/or the like.

Loss calculator 116 calculates loss 504 based on predicted output data 502 and optimized mixture ground-truth output data 503 included in optimized mixture data 123. In some embodiments, loss calculator 116 compares predicted output data 502 against optimized mixture ground-truth output data 503 using one or more task-appropriate loss functions. In some examples, loss functions can include cross-entropy loss for next-token prediction in language modeling, MSE for regression tasks, contrastive loss for representation learning, and/or sequence-level losses, such as bilingual evaluation understudy (BLEU) or Recall-Oriented Understudy for Gisting Evaluation (ROUGE) for translation and summarization tasks.

In some embodiments, model trainer 115 updates the parameters of language model 125 based on loss 504. In some embodiments, model trainer 115 applies an optimization algorithm, such as stochastic gradient descent (SGD), adaptive moment estimation (Adam), weighted Adam (AdamW), adaptive factorization (Adafactor), and/or the like, to minimize loss 504 by iteratively adjusting the parameters of language model 125. In some embodiments, model trainer 115 continues training until one or more stopping criteria are satisfied. Stopping criteria include, without limitation, (i) convergence of loss 504 to within a threshold tolerance across successive epochs, (ii) stabilization or improvement plateau of performance metrics (e.g., accuracy, perplexity, BLEU, or ROUGE) on a validation set, (iii) reaching a maximum number of training epochs or steps, or (iv) exhaustion of the allocated compute budget for training. Once trained, model trainer 115 stores the trained language model 125 in data store 120 or elsewhere.

FIG. 6 is a more detailed illustration of application 146, according to various embodiments. As shown, application 146 includes, without limitation, the trained language model 125. In operation, application 146 uses the trained language model 125 to process input data 601 and generate output data 602.

Trained language model 125 processes input data 601 and generates output data 602. Input data 601 includes, without limitation, typed or spoken natural language queries from a user, uploaded documents, code snippets, sensor data, and/or multimodal inputs, such as paired images and text, received from one or more I/O devices. Trained language model 125 uses learned parameters to transform optimized mixture input data 601 into output data 602.

FIG. 7 is a flow diagram of method steps for generating clustered data 121, according to various embodiments. Although the method steps are described in conjunction with the systems of FIGS. 1-6, persons skilled in the art will understand that any system configured to perform the method steps in any order falls within the scope of the present embodiments.

As shown, a method 700 begins with step 701, where embedding generator 310 receives corpus data 118. Corpus data 118 includes a large-scale collection of raw data that, for example, can include text documents, images, audio recordings, video content, software repositories, and/or other forms of digital data. In some embodiments, corpus data 118 includes a large dataset \hat{D}={D₁, D₂, . . . , Dₙ} including n data items, such as documents, images, audio recordings, or video segments.

At step 702, embedding generator 310 generates embeddings 301 based on corpus data 118. In some embodiments, embedding generator 310 maps each data item Dᵢ into an embedding space using an embedding model Mₑ.

At step 703, initial clustering generator 311 generates initial clusters 302 based on embeddings 301. In some embodiments, initial clustering generator 311 applies one or more clustering algorithms to group embeddings 301 into k clusters, C={C₁, C₂, . . . , Cₖ}, such that first embeddings 301 within the same cluster are more similar to each other than to second embeddings 301 in different clusters. For example, initial clustering generator 311 can apply a clustering algorithm, such as k-means clustering, hierarchical agglomerative clustering, spectral clustering, or DBSCAN.

At step 704, cluster pruner 312 prunes initial clusters 302 to generate pruned clusters 303. In some embodiments, cluster pruner 312 evaluates each initial cluster 302 according to one or more quality metrics and prunes initial clusters 302 that do not meet predefined criteria. The quality metrics include, without limitation, cluster size, intra-cluster similarity, inter-cluster separation, and/or domain relevance scores calculated by one or more auxiliary classifiers. For example, cluster pruner 312 can prune clusters based on scores computed across quality dimensions, such as overall quality, educational value, informational value, or advertisement level, using auxiliary models, such as fastText or large-scale classifiers. In some examples, a cluster-level pruning threshold (e.g., 3.0) is applied to reduce Kᵢₙᵢₜ=1000 initial clusters 302 down to K_{pruned}=240 pruned clusters 303. In some embodiments, cluster pruner 312 also discards initial clusters 302 that include fewer than a threshold number of items, clusters with low average similarity among embeddings, or clusters dominated by low-quality or noisy data, such as malformed text, corrupted images, or irrelevant audio fragments.

At step 705, cluster merger 313 merges pruned clusters 303 to generate clustered data 121. In some embodiments, cluster merger 313 merges similar fine-grained clusters included in pruned clusters 303 to reduce the overall number of clusters while preserving domain coherence. Specifically, given an initial number of clusters Kᵢₙᵢₜ, cluster pruner 312 reduces the set to K_{pruned} high-quality clusters. Cluster merger 313 then merges the K_{pruned} clusters into K_{enhanced} clusters according to the distance between cluster centroids, where K_{enhanced}<K_{pruned}<Kᵢₙᵢₜ. In some embodiments, cluster merger 313 groups clusters according to a Euclidean distance threshold, such as 1.5, ensuring that pruned clusters 303 with centroids closer than the threshold are merged.

FIG. 8 is a flow diagram of method steps for generating optimized mixture configuration 460, according to various embodiments. Although the method steps are described in conjunction with the systems of FIGS. 1-6, persons skilled in the art will understand that any system configured to perform the method steps in any order falls within the scope of the present embodiments.

As shown, a method 800 begins with step 801, where mixture bootstrapping module 119 receives clustered data 121. In some embodiments, clustered data 121 includes groups of related data items or clusters obtained by applying one or more clustering techniques, such as method 700, to corpus data 118, such that semantically or structurally similar items are grouped together into latent domains.

At step 802, mixture configuration generator 401 samples initial mixture configurations 402. In some embodiments, each mixture configuration specifies a set of mixture weights α={α₁, α₂, . . . , αₖ} assigned to the clusters included in clustered data 121. Each mixture weight αᵢ corresponds to a proportion of data sampled from cluster Dᵢ, such that the mixture configuration satisfies the normalization constraint

$${\sum }_{i = 1}^{k} {α}_{i} = 1$$

with αᵢ≥0. In some embodiments, at the first iteration, mixture configuration generator 401 initializes the mixture weights uniformly (e.g., αᵢ=1/k for all i) to permit balanced coverage across the clusters. In some embodiments, the mixture weights are initialized according to heuristics, such as cluster size, cluster quality scores, or external cluster priorities.

At step 803, proxy model trainer 412 trains proxy models 122 based on clustered data 121 and mixture configurations. In some embodiments, proxy model trainer 421 uses data included in clustered data 121 sampled according to mixture configurations, such as initial mixture configurations 402 during the first iteration of the bootstrapping or pruned mixture configurations 441 during subsequent iterations of the bootstrapping, as the training data. In some embodiments, proxy model trainer 421 selects a subset of training pairs (xᵢ, yᵢ). Proxy model trainer 421 updates the parameters of each proxy model 122 by minimizing a task-specific loss function [symbol] (ŷᵢ, yᵢ), where ŷᵢ is the output predicted by proxy model 122 for input xᵢ. In some examples, the loss function can include a cross-entropy loss for classification tasks, a mean squared error for regression tasks, a contrastive loss for representation learning tasks, a next token prediction loss for text generation tasks, and/or any other technically feasible loss. Proxy model trainer 421 performs one or more training operations until a convergence criterion is satisfied, such as reaching a maximum number of epochs, achieving a threshold validation accuracy, or meeting a predefined loss threshold. Once trained, proxy model trainer 421 stores the trained proxy models 122 in data store 120 or elsewhere.

At step 804, target data calculator 413 calculates, using the trained proxy models 122, target data 421 based on clustered data 121 and mixture configurations. In some embodiments, target data calculator 422 evaluates the performance of the trained proxy models 122 on benchmark tasks or validation datasets to generate measurable scores. For a given mixture configuration s included in at least one of initial mixture configurations 402 or pruned mixture configurations 441, and a corresponding trained proxy model 122 applied to data sampled according to s from clustered data 121, target data calculator 422 computes a vector of performance values [symbol] (s)=( [symbol] ₁(s), [symbol] ₂(s), . . . , [symbol] ₘ(s), where each [symbol] ⱼ(s) corresponds to the performance of the proxy model 122 on benchmark task j, measured using one or more evaluation metrics, such as accuracy, F1 score, BLEU, perplexity, MSE, and/or the like. Target data calculator 422 then calculates target values based on performance values and representing a single optimization objective that can be used to guide mixture selection. In some embodiments, target data calculator 422 computes a target value t(s)=g( [symbol] (s)), where g(·) is an aggregation function, such as averaging, weighted averaging, task-specific weighting, and/or the like. In some embodiments, the target values included in target data 421 are domain-specific.

At step 805, predictor model trainer 422 trains predictor model 124 based on mixture configurations and target data 421. In some embodiments, target data 421 includes one or more target values t(s) associated with mixture configurations s, where each target value reflects the aggregated performance of one of the proxy models 122 on benchmark tasks. Predictor model trainer 424 learns a mapping from mixture configurations to target values by fitting predictor model 124 on pairs (s, t(s)). In some examples, the training objective is to minimize a regression loss function as described in Equation 3. Predictor model trainer 422 performs one or more training operations until a convergence criterion is satisfied, such as reaching a maximum number of epochs, achieving a threshold validation accuracy, or meeting a predefined loss threshold. Once trained, predictor model trainer 422 stores the trained predictor model 122 in data store 120 or elsewhere.

At step 806, mixture bootstrapping module 119 determines whether to continue bootstrapping. In some embodiments, mixture bootstrapping module 119 continues bootstrapping until one or more stopping criteria are satisfied. Stopping criteria include, without limitation, (i) convergence of predicted target values across successive iterations, (ii) reaching a maximum number of iterations K, and/or (iii) exhaustion of the compute budget C allocated for training proxy models 122. In some embodiments, additional constraints are also applied, such as diversity requirements (e.g., ensuring that no single cluster dominates the mixture configurations), minimum thresholds for certain clusters, and/or domain-specific relevance filters. When mixture bootstrapping module 119 determines to continue bootstrapping, method 800 continues to step 807. When mixture bootstrapping module 119 determines not to continue bootstrapping, method 800 proceeds directly to step 809.

At step 807, mixture configuration generator 401 samples subsequent mixture configurations 431. In some embodiments, mixture configuration generator 401 generates subsequent mixture configurations 401 in a similar manner as described in step 802.

At step 808, mixture configuration pruner 440 prunes, using the trained predictor model 124, subsequent mixture configurations 431 to generate pruned mixture configurations 441. In some embodiments, mixture data pruner 440 uses predictor model 124 to discard low-scoring configurations included in subsequent mixture configurations 431 and retain promising configurations included in subsequent mixture configurations 431 for further evaluation. In some embodiments, pruning follows an iterative coordinate descent framework that alternates between configuration sampling and predictor fitting. In some examples, at iteration k, the unevaluated candidate configurations are scored by predictor model 124 as described in Equation 3. Mixture data pruner 440 then selects a subset S_{M}⊂Top_{N}(\tilde{P}^{(k)}) of high-scoring candidate configurations, either deterministically (e.g., top-N selection) or stochastically (e.g., random sampling from the top-N). For training a predictor model 124, the set of evaluated candidate configurations is expanded as S^{(k+1)}=S^{(k)} U S_{M}. In some examples, the optimization objective at iteration k for training a predictor model 124 during the subsequent iteration using pruned mixture configurations 441 and target data 421 generated by proxy models 122 trained using pruned mixture configurations 441, as well as previously generated mixture configurations and associated target data (if any), is expressed as given in Equation 4 with predictor model 124 updated according to Equation 5. After step 808, method 800 returns to step 803, where proxy model trainer 412 trains additional proxy models 122 based on clustered data 121 and the pruned mixture configurations 441.

At step 809, which occurs when mixture bootstrapping module 119 determines not to continue bootstrapping at step 806, optimization module 450 generates optimized mixture configuration using predictor model 124. In some embodiments, optimization module 450 uses the trained predictor model 124 to evaluate a large number of candidate mixture configurations (e.g., 100,000 randomly sampled mixture configurations) and selects optimized mixture configuration 460 predicted to yield the best performance.

FIG. 9 is a flow diagram of method steps for training language model 125, according to various embodiments. Although the method steps are described in conjunction with the systems of FIGS. 1-6, persons skilled in the art will understand that any system configured to perform the method steps in any order falls within the scope of the present embodiments.

As shown, a method 900 begins with step 901, where training data generator 113 receives optimized mixture configuration 460 and clustered data 121. Optimized mixture configuration 460 includes, without limitation, the mixture weights, sampling proportions, and/or cluster assignments for clustered data 121. Clustered data 121 includes groups of related data items obtained by applying one or more clustering techniques, such as the method 700, to corpus data 118, such that semantically or structurally similar items are grouped together into latent domains.

At step 902, training data generator 113 generates optimized mixture data 123 based on optimized mixture configuration 460 and clustered data 121. In some embodiments, optimized mixture configuration 460 specifies mixture weights or sampling proportions across one or more clusters included in clustered data 121. Training data generator 113 applies the mixture weights to select and combine the clusters from clustered data 121, generating optimized mixture data 123. The resulting optimized mixture data 123 includes both the selected clusters and the mixture weights that govern the composition. Once optimized mixture data 123 is generated, training data generator 113 stores optimized mixture data 123 in data store 120 or elsewhere.

At step 903, language model 125 generates predicted output data 502 based on optimized mixture input data 501 included in optimized mixture data 123. In some embodiments, optimized mixture input data 501 includes training examples drawn according to optimized mixture configuration 460, such as text sequences, image-caption pairs, code snippets, and/or multimodal data items. Language model 125 uses the learned parameters to transform optimized mixture input data 501 into predicted output data 502, which can include next-token predictions, classifications, embeddings, and/or other task-specific outputs depending on the training objective.

At step 904, loss calculator 116 calculates loss 504 based on predicted output data 502 and optimized mixture ground-truth output data 503 included in optimized mixture data 123. In some embodiments, loss calculator 116 compares predicted output data 502 against optimized mixture ground-truth output data 503 using one or more task-appropriate loss functions. In some examples, the loss functions can include cross-entropy loss for next-token prediction in language modeling, MSE for regression tasks, contrastive loss for representation learning, and/or sequence-level losses, such BLEU or ROUGE for translation and summarization tasks.

At step 905, model trainer 115 updates parameters of language model 125 based on loss 504. In some embodiments, model trainer 115 applies an optimization algorithm, such as SGD, Adam, AdamW, Adafactor, and/or the like, to minimize loss 504 by iteratively adjusting the parameters of language model 125.

At step 906, model trainer 115 determines whether to continue training. In some embodiments, model trainer 115 continues training until one or more stopping criteria are satisfied. Stopping criteria can include, without limitation, (i) convergence of the loss 504 to within a threshold tolerance across successive epochs, (ii) stabilization or improvement plateau of performance metrics (e.g., accuracy, perplexity, BLEU, or ROUGE) on a validation set, (iii) reaching a maximum number of training epochs or steps, or (iv) exhaustion of the allocated compute budget for training. When model trainer 115 determines to continue training, method 900 returns to step 903. When model trainer 115 determines not to continue training, model trainer 115 stores the trained language model 125 in data store 120 or elsewhere and method 900 terminates.

FIG. 10 is a flow diagram of method steps for generating output data 602 using a trained language model 125, according to various embodiments. Although the method steps are described in conjunction with the systems of FIGS. 1-6, persons skilled in the art will understand that any system configured to perform the method steps in any order falls within the scope of the present embodiments.

As shown, a method 1000 begins with step 1001, where application 146 receives input data 601. Input data 601 includes, without limitation, typed or spoken natural language queries from a user, uploaded documents, code snippets, sensor data, and/or multimodal inputs, such as paired images and text, received from one or more I/O devices.

At step 1002, application 146 generates, using trained language model 125, output data 602 based on input data 601. In some embodiments, trained language model 125 uses the learned parameters to transform optimized mixture input data 601 into output data 602.

In sum, techniques are disclosed for iterative bootstrapping for mixture data generation. In some embodiments, a clustering module processes a corpus of text data and generates clustered data that includes clusters of the text data. The clustering module includes an embedding generator, an initial clustering generator, a cluster pruner, and a cluster merger. The embedding generator processes the corpus data and generates one or more embeddings. The initial clustering generator clusters the embeddings and generates one or more initial clusters. The cluster pruner prunes the initial clusters and generates pruned clusters. The cluster merger performs merging on the pruned clusters to generate the clustered data. In addition, a mixture bootstrapping module performs one or more bootstrapping operations to generate an optimized mixture configuration based on the clustered data. The mixture bootstrapping module includes a mixture configuration generator, a mixture configuration pruner, a proxy model training module, a predictor model training module, and an optimization module. The proxy model training module includes one or more proxy models, a proxy model trainer, and a target data calculator. The predictor model training module includes target data, a predictor model trainer, and a predictor model. The mixture configuration pruner includes the predictor model. The optimization module includes the predictor model. During a first iteration of the bootstrapping, the mixture configuration generator processes clustered data and generates initial mixture configurations. The proxy model trainer trains proxy models based on the clustered data and the initial mixture configurations. Once trained, the target data calculator uses the proxy models to calculate target data that indicates the performance of each proxy model trained with one of the initial mixture configurations. The predictor model trainer then trains a predictor model based on the initial mixture configurations and the corresponding target data. At a subsequent iteration, the mixture configuration generator processes clustered data to generate subsequent mixture configurations. The mixture configuration pruner uses the trained predictor model to prune the subsequent mixture configurations, generating pruned mixture configurations. The proxy model trainer then trains the proxy models based on the clustered data and the pruned mixture configurations. Once trained, the target data calculator uses the proxy models to calculate target data corresponding to the pruned mixture configurations. The predictor model trainer trains the predictor model based on all evaluated mixture configurations, including both initial mixture configurations and pruned mixture configurations and the associated target data. The bootstrapping operations continue across multiple iterations, with the mixture configuration generator generating new candidate mixture configurations, the mixture configuration pruner refining the candidate mixture configurations using the predictor model, the proxy model trainer training proxy models, the target data calculator generating target data, and the predictor model trainer training a new predictor model. The bootstrapping operations continue until one or more stopping criteria are met. When bootstrapping is complete, the optimization module uses the trained predictor model from the last iteration to evaluate a large number of candidate mixture configurations and selects the optimized mixture configuration predicted that achieves the best predicted performance. In some embodiments, a model trainer trains a language model based on the optimized mixture configurations and the clustered data. A training data generator processes the clustered data and the optimized mixture configuration and generates optimized mixture data, which includes optimized mixture input data and optimized mixture ground-truth output data. The language model processes the optimized mixture input data and generates predicted output data. A loss calculator compares the predicted output data with the optimized mixture ground-truth output data and calculates a loss. The model trainer uses the loss to update the parameters of the language model. The training continues until one or more stopping criteria are met. Once trained, the trained language model can be used by an application to process input data and generate output data.

At least one technical advantage of the disclosed techniques relative to the prior art is that the disclosed techniques overcome the lack of explicit domain labels and the difficulty of selecting optimal mixture data by clustering corpus data into semantically meaningful clusters that act as effective substitutes for domain labels, enabling more accurate identification of relevant data types without requiring manual annotation. The disclosed techniques also use machine learning models to iteratively evaluate, prune, and optimize mixture configurations, which can automatically determine the proportions of complementary data types that yield better performance when used to train a language model. These technical advantages provide one or more technological improvements over prior art approaches.

1. In some embodiments, a computer-implemented method for training a language model comprises generating, based on corpus data, clustered data, performing, based on the clustered data, a plurality of bootstrapping operations to train a first predictor model and generate a mixture configuration, generating, based on the mixture configuration and the clustered data, mixture data, and performing, based on the mixture data, one or more training operations to train a first untrained language model to generate a first trained language model, wherein the first trained language model processes first input data to generate first output data.

2. The computer-implemented method of clause 1, wherein generating the clustered data comprises generating, based on the corpus data, one or more embeddings, clustering the one or more embeddings to generate a plurality of initial clusters, pruning the plurality of initial clusters to generate a plurality of pruned clusters, and merging at least two of the plurality of pruned clusters to generate the clustered data.

3. The computer-implemented method of clauses 1 or 2, wherein generating the one or more embeddings comprises mapping a data item included in the corpus data into an embedding space using an embedding model.

4. The computer-implemented method of any of clauses 1-3, wherein pruning the plurality of initial clusters to generate the plurality of pruned clusters comprises pruning, based on one or more scores, the plurality of initial clusters, wherein the one or more scores are computed across one or more quality dimensions using one or more auxiliary models.

5. The computer-implemented method of any of clauses 1-4, wherein performing the plurality of bootstrapping operations comprises performing, based on one or more first mixture configurations and the clustered data, one or more training operations to train one or more untrained language models to generate one or more trained language models, calculating, based on the clustered data and the one or more first mixture configurations, and using the one or more trained language models, target data, and performing, based on the one or more first mixture configurations and the target data, one or more training operations to train a first untrained predictor model to generate the first trained predictor model, wherein the first trained predictor model is trained to generate one or more first target values.

6. The computer-implemented method of any of clauses 1-5, wherein calculating the target data comprises computing, based on the one or more first mixture configurations and the clustered data, one or more performance values, wherein a first performance value included in the one or more performance values corresponds to a performance of a first trained language model included in the one or more trained language models on a benchmark task, and calculating, based on the one or more performance values and using an aggregation function, one or more second target values included in the target data.

7. The computer-implemented method of any of clauses 1-6, further comprising pruning one or more second mixture configurations using a second trained predictor model to generate the one or more first mixture configurations.

8. The computer-implemented method of any of clauses 1-7, wherein the first untrained predictor model is further trained based on one or more second mixture configurations and associated target data from one or more previous iterations of the plurality of bootstrapping operations.

9. The computer-implemented method of any of clauses 1-8, wherein performing the plurality of bootstrapping operations further comprises generating one or more second mixture configurations, and selecting the mixture configuration from the one or more second mixture configurations using the first trained predictor model.

10. The computer-implemented method of any of clauses 1-9, wherein performing the plurality of bootstrapping operations further comprises performing, based on one or more second mixture configurations and the clustered data, one or more training operations to train one or more additional untrained language models to generate one or more additional trained language models, calculating, based on the clustered data and the one or more second mixture configurations, and using the one or more additional trained language models, additional target data, and performing, based on the one or more second mixture configurations and the additional target data, one or more training operations to train a second untrained predictor model to generate a second trained predictor model, wherein the one or more first mixture configurations are generated by pruning one or more third mixture configurations using the second trained predictor model, and wherein performing one or more operations to train the first untrained predictor model is further based on the one or more second mixture configurations and the additional target data.

11. In some embodiments, one or more non-transitory computer-readable media store instructions that, when executed by one or more processors, cause the one or more processors to perform the steps of generating, based on corpus data, clustered data, performing, based on the clustered data, a plurality of bootstrapping operations to train a first predictor model and generate a mixture configuration, generating, based on the mixture configuration and the clustered data, mixture data, and performing, based on the mixture data, one or more training operations to train a first untrained language model to generate a first trained language model, wherein the first trained language model processes first input data to generate first output data.

12. The one or more non-transitory computer-readable media of clause 11, wherein generating the clustered data comprises generating, based on the corpus data, one or more embeddings, clustering the one or more embeddings to generate a plurality of initial clusters, pruning the plurality of initial clusters to generate a plurality of pruned clusters, and merging at least two of the plurality of pruned clusters to generate the clustered data.

13. The one or more non-transitory computer-readable media of clauses 11 or 12, wherein performing the plurality of bootstrapping operations comprises performing, based on one or more first mixture configurations and the clustered data, one or more training operations to train one or more untrained language models to generate one or more trained language models, calculating, based on the clustered data and the one or more first mixture configurations, and using the one or more trained language models, target data, and performing, based on the one or more first mixture configurations and the target data, one or more training operations to train a first untrained predictor model to generate the first trained predictor model, wherein the first trained predictor model is trained to generate one or more first target values.

14. The one or more non-transitory computer-readable media of any of clauses 11-13, wherein calculating the target data comprises computing, based on the one or more first mixture configurations and the clustered data, one or more performance values, wherein a first performance value included in the one or more performance values corresponds to a performance of a first trained language model included in the one or more trained language models on a benchmark task, and calculating, based on the one or more performance values and using an aggregation function, one or more second target values included in the target data.

15. The one or more non-transitory computer-readable media of any of clauses 11-14, wherein the instructions, when executed by the one or more processors, further cause the one or more processors to perform the step of pruning one or more second mixture configurations using a second trained predictor model to generate the one or more first mixture configurations.

16. The one or more non-transitory computer-readable media of any of clauses 11-15, wherein performing the plurality of bootstrapping operations further comprises performing, based on one or more second mixture configurations and the clustered data, one or more training operations to train one or more additional untrained language models to generate one or more additional trained language models, calculating, based on the clustered data and the one or more second mixture configurations, and using the one or more additional trained language models, additional target data, and performing, based on the one or more second mixture configurations and the additional target data, one or more training operations to train a second untrained predictor model to generate a second trained predictor model, wherein the one or more first mixture configurations are generated by pruning one or more third mixture configurations using the second trained predictor model, and wherein performing one or more operations to train the first untrained predictor model is further based on the one or more second mixture configurations and the additional target data.

17. The one or more non-transitory computer-readable media of any of clauses 11-16, wherein the first predictor model comprises one or more gradient-boosted decision trees.

18. The one or more non-transitory computer-readable media of any of clauses 11-17, wherein performing the one or more training operations to train the first untrained language model to generate the first trained language model comprises generating, based on input data included in the mixture data and using the first untrained language model, predicted output data, calculating, based on the predicted output data and output data included in the mixture data, a loss, and updating, based on the loss, one or more parameters of the first untrained language model.

19. The one or more non-transitory computer-readable media of any of clauses 11-18, wherein the first input data comprises first text data, and wherein the first output data comprises second text data.

20. In some embodiments, a system comprises one or more memories storing instructions, and one or more processors that are coupled to the one or more memories and, when executing the instructions, are configured to generate, based on corpus data, clustered data, perform, based on the clustered data, a plurality of bootstrapping operations to train a first predictor model and generate a mixture configuration, generate, based on the mixture configuration and the clustered data, mixture data, and perform, based on the mixture data, one or more training operations to train a first untrained language model to generate a first trained language model, wherein the first trained language model processes first input data to generate first output data.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a language model, the method comprising:
generating, based on corpus data, clustered data;
performing, based on the clustered data, a plurality of bootstrapping operations to train a first predictor model and generate a mixture configuration;
generating, based on the mixture configuration and the clustered data, mixture data; and
performing, based on the mixture data, one or more training operations to train a first untrained language model to generate a first trained language model,
wherein the first trained language model processes first input data to generate first output data.

2. The computer-implemented method of claim 1, wherein generating the clustered data comprises:
generating, based on the corpus data, one or more embeddings;
clustering the one or more embeddings to generate a plurality of initial clusters;
pruning the plurality of initial clusters to generate a plurality of pruned clusters; and
merging at least two of the plurality of pruned clusters to generate the clustered data.

3. The computer-implemented method of claim 2, wherein generating the one or more embeddings comprises mapping a data item included in the corpus data into an embedding space using an embedding model.

4. The computer-implemented method of claim 2, wherein pruning the plurality of initial clusters to generate the plurality of pruned clusters comprises pruning, based on one or more scores, the plurality of initial clusters, wherein the one or more scores are computed across one or more quality dimensions using one or more auxiliary models.

5. The computer-implemented method of claim 1, wherein performing the plurality of bootstrapping operations comprises:
performing, based on one or more first mixture configurations and the clustered data, one or more training operations to train one or more untrained language models to generate one or more trained language models;
calculating, based on the clustered data and the one or more first mixture configurations, and using the one or more trained language models, target data; and
performing, based on the one or more first mixture configurations and the target data, one or more training operations to train a first untrained predictor model to generate the first trained predictor model, wherein the first trained predictor model is trained to generate one or more first target values.

6. The computer-implemented method of claim 5, wherein calculating the target data comprises:
computing, based on the one or more first mixture configurations and the clustered data, one or more performance values, wherein a first performance value included in the one or more performance values corresponds to a performance of a first trained language model included in the one or more trained language models on a benchmark task; and
calculating, based on the one or more performance values and using an aggregation function, one or more second target values included in the target data.

7. The computer-implemented method of claim 5, further comprising pruning one or more second mixture configurations using a second trained predictor model to generate the one or more first mixture configurations.

8. The computer-implemented method of claim 5, wherein the first untrained predictor model is further trained based on one or more second mixture configurations and associated target data from one or more previous iterations of the plurality of bootstrapping operations.

9. The computer-implemented method of claim 5, wherein performing the plurality of bootstrapping operations further comprises:
generating one or more second mixture configurations; and
selecting the mixture configuration from the one or more second mixture configurations using the first trained predictor model.

10. The computer-implemented method of claim 5, wherein performing the plurality of bootstrapping operations further comprises:
performing, based on one or more second mixture configurations and the clustered data, one or more training operations to train one or more additional untrained language models to generate one or more additional trained language models;
calculating, based on the clustered data and the one or more second mixture configurations, and using the one or more additional trained language models, additional target data; and
performing, based on the one or more second mixture configurations and the additional target data, one or more training operations to train a second untrained predictor model to generate a second trained predictor model,
wherein the one or more first mixture configurations are generated by pruning one or more third mixture configurations using the second trained predictor model, and
wherein performing one or more operations to train the first untrained predictor model is further based on the one or more second mixture configurations and the additional target data.

11. One or more non-transitory computer-readable media storing instructions that, when executed by one or more processors, cause the one or more processors to perform the steps of:
generating, based on corpus data, clustered data;
performing, based on the clustered data, a plurality of bootstrapping operations to train a first predictor model and generate a mixture configuration;
generating, based on the mixture configuration and the clustered data, mixture data; and
performing, based on the mixture data, one or more training operations to train a first untrained language model to generate a first trained language model,
wherein the first trained language model processes first input data to generate first output data.

12. The one or more non-transitory computer-readable media of claim 11, wherein generating the clustered data comprises:
generating, based on the corpus data, one or more embeddings;
clustering the one or more embeddings to generate a plurality of initial clusters;
pruning the plurality of initial clusters to generate a plurality of pruned clusters; and
merging at least two of the plurality of pruned clusters to generate the clustered data.

13. The one or more non-transitory computer-readable media of claim 11, wherein performing the plurality of bootstrapping operations comprises:
performing, based on one or more first mixture configurations and the clustered data, one or more training operations to train one or more untrained language models to generate one or more trained language models;
calculating, based on the clustered data and the one or more first mixture configurations, and using the one or more trained language models, target data; and
performing, based on the one or more first mixture configurations and the target data, one or more training operations to train a first untrained predictor model to generate the first trained predictor model, wherein the first trained predictor model is trained to generate one or more first target values.

14. The one or more non-transitory computer-readable media of claim 13, wherein calculating the target data comprises:
computing, based on the one or more first mixture configurations and the clustered data, one or more performance values, wherein a first performance value included in the one or more performance values corresponds to a performance of a first trained language model included in the one or more trained language models on a benchmark task; and
calculating, based on the one or more performance values and using an aggregation function, one or more second target values included in the target data.

15. The one or more non-transitory computer-readable media of claim 13, wherein the instructions, when executed by the one or more processors, further cause the one or more processors to perform the step of pruning one or more second mixture configurations using a second trained predictor model to generate the one or more first mixture configurations.

16. The one or more non-transitory computer-readable media of claim 13, wherein performing the plurality of bootstrapping operations further comprises:
performing, based on one or more second mixture configurations and the clustered data, one or more training operations to train one or more additional untrained language models to generate one or more additional trained language models;
calculating, based on the clustered data and the one or more second mixture configurations, and using the one or more additional trained language models, additional target data; and
performing, based on the one or more second mixture configurations and the additional target data, one or more training operations to train a second untrained predictor model to generate a second trained predictor model,
wherein the one or more first mixture configurations are generated by pruning one or more third mixture configurations using the second trained predictor model, and
wherein performing one or more operations to train the first untrained predictor model is further based on the one or more second mixture configurations and the additional target data.

17. The one or more non-transitory computer-readable media of claim 11, wherein the first predictor model comprises one or more gradient-boosted decision trees.

18. The one or more non-transitory computer-readable media of claim 11, wherein performing the one or more training operations to train the first untrained language model to generate the first trained language model comprises:
generating, based on input data included in the mixture data and using the first untrained language model, predicted output data;
calculating, based on the predicted output data and output data included in the mixture data, a loss; and
updating, based on the loss, one or more parameters of the first untrained language model.

19. The one or more non-transitory computer-readable media of claim 11, wherein the first input data comprises first text data, and wherein the first output data comprises second text data.

20. A system, comprising:
one or more memories storing instructions; and
one or more processors that are coupled to the one or more memories and, when executing the instructions, are configured to:
generate, based on corpus data, clustered data,
perform, based on the clustered data, a plurality of bootstrapping operations to train a first predictor model and generate a mixture configuration,
generate, based on the mixture configuration and the clustered data, mixture data, and
perform, based on the mixture data, one or more training operations to train a first untrained language model to generate a first trained language model,
wherein the first trained language model processes first input data to generate first output data.
